(19) United States
(12) Patent Application Publication
(10) Pub. No.: US 2014/0020928 A1
(43) Pub. Date: Jan. 23, 2014

(54) APPARATUS AND METHOD FOR MANIPULATING A FLAT CORD

(71) Applicant: Moxytronix, (US)

(72) Inventor: Jason G. Johnson, Henderson, NV (US)

(73) Assignee: MOXYTRONIX, Henderson, NV (US)

(21) Appl. No.: 13/735,708

(22) Filed: Jan. 7, 2013

Related U.S. Application Data
(60) Provisional application No. 61/584,218, filed on Jan. 7, 2012.

(51) Int. Cl. H01B 7/06

(52) U.S. Cl. CPC H01B 7/06
USPC 174/110 R

(57) ABSTRACT

Apparatus and method that includes a sheath defining a passage through which a flat cord is adapted to extend, the width of the sheath being greater than its height and the width of the cord being greater than its height, the width of the sheath and the width of the cord being substantially aligned. After stretching and permitting the sheath to retract, a second amount of the cord is disposed within the sheath, with the second amount being greater than the first amount, and wherein, in each configuration, the width of the sheath and the width of the cord remain substantially aligned.

### CROSS-REFERENCE TO RELATED APPLICATIONS

The present application is a utility patent application which depends from and incorporates by reference U.S. Provisional Patent Application No. 61,584,218 filed on Jan. 7, 2012 entitled “Flat Cord Manifestation,” the disclosure of which is incorporated herein as if set forth in its entirety.

### BACKGROUND OF THE INVENTION

This invention relates generally to an apparatus and method for manipulating a flat cord, with the manipulation including but not limited to storing, packaging, collapsing or extending the cord in or from a sheath, in such a manner that the side of the sheath does not rotate and, consequently, remains substantially flat, during use.

Sheaths for protecting and storing cords are known in the art. One such sheath is disclosed in U.S. Pat. No. 7,202,414 naming the same inventor as the invention described herein, and the disclosure of which is incorporated herein as if set forth in its entirety. However, sheaths and cords of the prior art are generally round and do not maintain a common axis as the cord enters, exits and resides in the sheath. In other words, sheaths of the prior art may rotate around the cord as the sheath is extended and retracted. Because of this, a message, logo or imprint that is printed on, or affixed to, the sheath would appear unreadable.

There is a need, therefore, for an apparatus and method which includes a sheath defining a passage through which a flat cord is adapted to extend, the width of the sheath being greater than its height and the width of the cord being greater than its height; wherein the width of the sheath and the width of the cord remain substantially aligned throughout use and storage of the cord.

### SUMMARY OF THE INVENTION

According to one embodiment of the present invention, an apparatus is provided that includes a sheath defining a passage through which a flat cord is adapted to extend, the width of the sheath being greater than its height and the width of the cord being greater than its height; wherein the sheath comprises a first configuration in which the sheath has a first length, and a first amount of the cord is disposed within the passage when the cord extends through the passage; a second configuration in which the sheath has a second length wherein the second length is greater than the first length; and a third configuration in which the cord extends through the sheath and at least a portion of the internal surface of the sheath engages at least a portion of the cord, and a second amount of the cord is disposed within the passage wherein the second amount of the cord is greater than the first amount of the cord, and wherein, in each configuration, the width of the sheath and the width of the cord remain substantially aligned.

In use, the flat cord is extended through the sheath having a first length so that a first amount of the cord is disposed within the sheath, the sheath is stretched to a second length that is greater than the first length, and the sheath is permitted to retract to a third length that is less than the second length so that a second amount of the cord is disposed within the sheath wherein the second amount is greater than the first amount and, throughout such use, the width of the sheath and the width of the cord remain substantially aligned.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A shows an elevation view of an apparatus according to one embodiment of the present invention;

FIG. 1B shows a top view of the apparatus of FIG. 1A;

FIG. 1C is a partial cross-sectional view of a portion of the apparatus of FIG. 1A;

FIG. 2 shows an elevation view of the apparatus of FIG. 1 in a configuration in which the cord is partially extended from the sheath;

FIG. 3 shows an elevation view of the apparatus of FIG. 1 in a configuration in which the cord is fully extended from the sheath;

FIG. 4 is an elevation view of the apparatus of FIG. 1 depicting the extension of the sheath to cover the cord;

FIG. 5 is an elevation view of the apparatus of FIG. 1 in which the sheath is fully extended; and

FIG. 6 is an elevation view of the apparatus of FIG. 1 in a configuration substantially similar to the configuration of FIG. 1.

### DETAILED DESCRIPTION OF THE INVENTION

The present invention is directed to an apparatus and method of utilizing a flat cord within an elastic storage sheath. The configuration and use of the presently preferred embodiments are discussed in detail below. It should be appreciated, however, that the present invention provides many applicable inventive concepts that can be embodied in a wide variety of contexts other than storage and use of an electronic cord. Accordingly, the specific embodiments discussed are merely illustrative of specific ways to make and use the invention, and do not limit the scope of the invention. In addition, the following terms shall have the associated meaning when used herein:
“cord” means and includes electrical and non-electrical cable (including ribbon cables), cable assemblies, wire, wire assemblies, cable harnesses assemblies, cords, strings, ropes, lines, twines, threads, braided bands, tape, tubing, tethers, fabrics, meshes, sheets, and similar materials or combinations thereof;
“flat” means and includes any configuration in which the width is greater than the height; and
“sheath” means and includes any type of covering which generally surrounds the cord, including any type of sleeve, jacket, sheath, tubing or the like made of any type of material capable of elastic deformation.

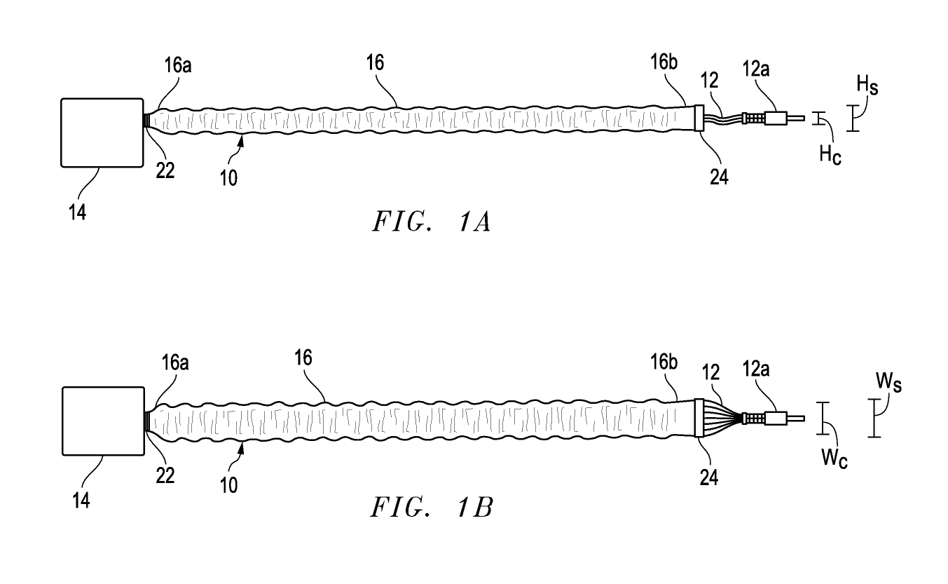

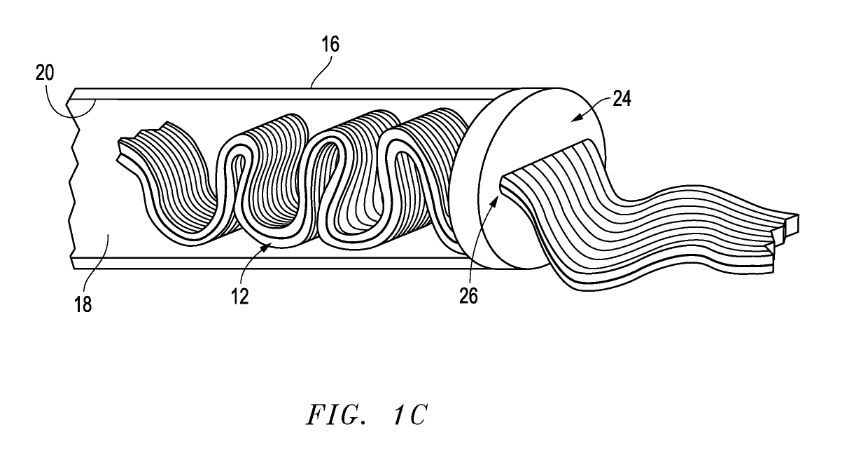

Referring now to FIGS. 1A, 1B and 1C which show elevation, top and cross- sectional views, respectively, of an apparatus according to one embodiment of the present invention. A cord 12 is extended from an electronic device, such as from a power adapter 14. A plug element 12a is connected to the distal end of the cord 12. Apparatus 10 includes a sheath 16 defining a passage 18 through which the cord 12 extends. The sheath 16 is configured to stretch and retract as more fully set forth herein. An internal surface 20 of the sheath 16 is defined by the passage 18, and at least a portion of the internal surface 20 is engaged with at least a portion of the cord 12. As can be seen is FIGS. 1A, 1B and 1C, the width (Ws) of the sheath 16 is greater than the height (Hs) of the sheath 16 and the width (Wc) of the cord 12 is greater than the height (Hc) of the cord 12, such that both the sheath 16 and the cord 12 are considered flat for purposes hereof.

A clip 22 extends at least partially circumferentially about an end portion 16a of the sheath 16 and the proximal end portion of the cord 12 disposed within the end portion 16a of the sheath 16, clamping the end portion 16a of the sheath 16 against the proximal end portion of the cord 12 and thereby substantially fixing the end portion 16a of sheath 16 relative to the cord 12.

A fitting 24 is generally in the form of an annular member through which the cable 12 extends and is partially inserted into the passage 18 at an end portion 16b of the sheath 16 so that the sheath 16 grips the fitting, thereby connecting and securing the fitting 24 to the sheath 16. As can be seen in FIG. 1C, the fitting 24 may be used to prevent rotation about the longitudinal axis of the flat cord 12 within the elastic sheath 16, such as twisting clockwise or counter-clockwise of the flat cord 12 during the storage cycle. The fitting 24 may utilize a slit entrance 26. In one embodiment, the slit entrance 26 may prevent the flat cord 26 from twisting during the release and storage cycle and may keep the undulation of the stored cord 12 uniform.

In use, the sheath 16 may be in the configuration depicted in FIGS. 1A, 1B and 1C, with the sheath 16 in a crumpled condition and large amount, or the majority, of the cord 12 at least partially crumpled and disposed within the passage 18. The opening 26 aligns the cord and the internal surface 20 of the sheath 16 engages the cord 12 at several points along the longitudinal length of the sheath 16 so that at least portions of the sheath 16 conform to and/or grip the corresponding portions of the cord 12, thereby resisting rotational movement between the sheath 16 and the cord 12. Because the flat cord 12 and the flat sheath 16 remain in substantial alignment during use, it is possible to imprint messages, logos, indicia, marking and the like along the width of the sheath 16, the cord 12, or both.

When desired, the sheath 16 may then be placed in the configuration depicted in FIG. 2 by moving the plug element 12a in a direction away from the fitting 24, thereby reducing the amount of the cord 12 disposed within the passage 18 and defining a crumpled portion 16c and a relaxed portion 16d of the sheath 16, although it will be appreciated by those skilled in the art that the relaxed portion 16d need not be entirely contiguous and that relaxed portions 16d may be interspersed with crumpled portions 16c at various times during use . The longitudinal lengths of the crumpled portion 16c and the relaxed portion 16d are dependent upon the amount of the portion of the cord 12 that moved out from the passage 18 of the sheath 16. That is, as the plug element 12a is moved away from the fitting 24, the cord 12 also travels through the fitting 24 and out of the passage 18 of the sheath 16. As the cord 12 so travels, the cord 12 disengages from the corresponding portions of the internal surface 20 of the sheath 16 so that the corresponding portions of the sheath 16 no longer conform to and/or grip the cord 12, thereby defining the longitudinal length of the relaxed portion 16d of the sheath 16. The longitudinal length of the crumpled portion 16c of the sheath 16 is, in turn, defined by the longitudinal length of the relaxed portion 16d of the sheath 16.

As much of the cord 12 as desired may be moved out from the passage 18 of the sheath 16 for any desired reason such as, for example, initiating conventional operation of the power adapter 14 by inserting the plug element 12a into a receptacle (it is understood that the power adapter 14 may be plugged into a conventional power outlet to effect this conventional operation). The crumpled portion 16c of the sheath 16 continues to conform to and/or grip portions of the cord 12, thereby continuing to resist relative rotation between the sheath 16 and the cord 12 thereby allowing the sheath 16 to retain a substantially flat configuration.

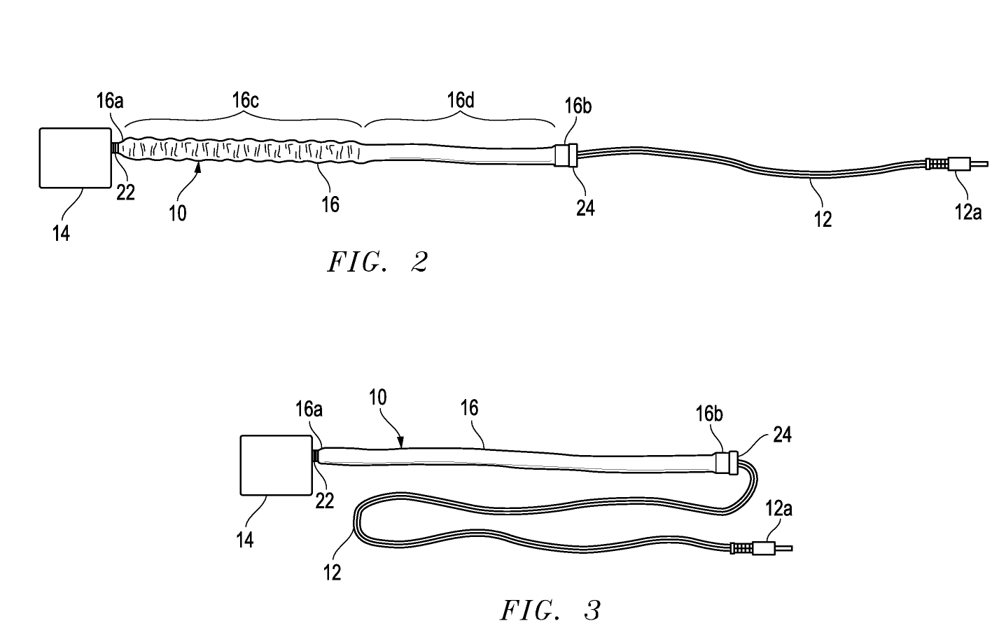

If desired, the sheath 16 may then be placed in the configuration depicted in FIG. 3 by continuing to move the plug element 12a in a direction away from the fitting 24 so that a minimum amount of the cord 12 is disposed within the passage 18 and a maximum amount of the cord 12 extends outside of the passage 18. As shown in FIG. 3, no portion of the sheath 16 between the end portions 16a and 16b conforms to and/or grips any portion of the cord 12 and thus the entire length of the sheath 16 extending between the end portions 16a and 16b is in a relaxed condition.

The amount of the cord 12 disposed within the passage 18 of the sheath 16 may be varied as desired or as dictated by environmental constraints such as, for example, the position of the conventional power outlet to which the power adapter 14 is connected and the position of the receptacle into which the plug element 12a is inserted during the operation of the power adapter 14. As the amount of the cord 12 disposed within the passage 18 of the sheath 16 is varied, the amount of the cord 12 extending outside of the passage 18 is correspondingly varied.

The flat cord's 12 geometry may facilitate an efficient and aesthetic method of storing the cord 12 within the sheath 16 in an undulating configuration. When the elastic sheath 16 is stretched and engages the cord 12, such as during the storage cycle, the flexible flat cord 12 may be stored in a natural undulation and may present a tidy four sided tube in the storage configuration.

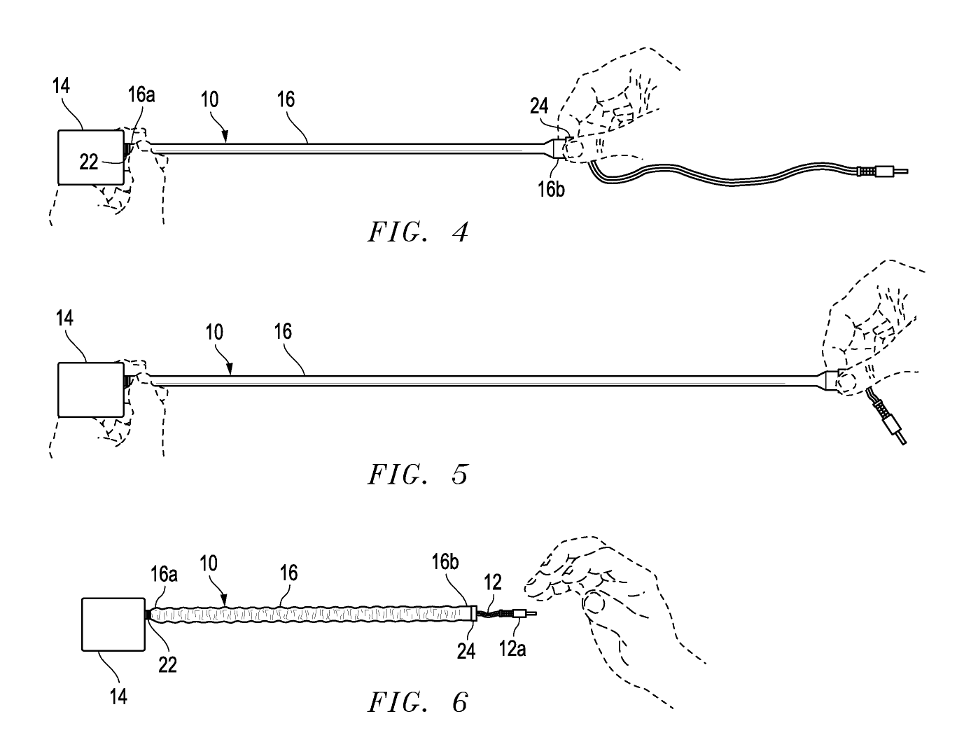

The sheath 16 may be placed in the configuration depicted in FIG. 4 by grasping the fitting 24 and/or the end portion 16b of the sheath 16 and moving it away from the clip 22 and the power adapter 14, with the position of the end portion 16a of the sheath 16 and the clip 22 clamped therearound remaining substantially constant, thereby increasing the length of, and stretching the sheath 16 over, the cord 12. Thus, an increased amount of the cord 12 is disposed within the passage 18 of the sheath 16, in comparison to the amount of the cord 12 disposed within the passage 18 of the sheath 16 in the configuration of FIG. 3. Moreover, due to the stretching of the sheath 16, the cross-sectional area of the passage 18 of the sheath 16 in the configuration of FIG. 4, at one or more locations along the longitudinal length of the sheath 16, is less than the cross-sectional area of the passage 18 of the sheath 16 in the configuration of FIG. 3, at the corresponding one or more locations along the longitudinal length of the sheath 16.

The sheath 16 may be placed in the configuration depicted in FIG. 5 by continuing to stretch the sheath 16 over the cord 12 so that length of the sheath 16 continues to increase and an increased amount of the cord 12 is disposed within the passage 18 of the sheath 16, in comparison to the amount of the cord 12 disposed within the passage 18 of the sheath 16 in the configuration of FIG. 4. Moreover, due to the additional stretching of the sheath 16, the cross-sectional area of the passage 18 of the sheath 16 in the configuration of FIG. 5, at one or more locations along the longitudinal length of the sheath 16, is less than the cross-sectional area of the passage 18 of the sheath 16 in the configuration of FIG. 4, at the corresponding one or more locations along the longitudinal length of the sheath 16.

The sheath 16 may be placed in the configuration depicted in FIG. 6 by permitting the sheath 16 to retract so that the fitting 24 moves from the position shown in FIG. 5 to the position shown in FIG. 6 and the length of the sheath 16 decreases. During retraction, at least a portion of the internal surface 20 of the sheath 16 engages at least a portion of the cord 12 so that the sheath 16 at least partially conforms to and/or grips the portion of the cord 12.

Due to the engagement between the internal surface 20 and the cord 12, the portion of the cord 12 disposed within the passage 18 in the stretched configuration of FIG. 5 remains oriented within the passage 18 as the sheath 16 is permitted to retract. Since the overall length of the sheath 16 decreases during the retraction, and the amount of the cord 12 within the passage 18 remains substantially constant, the internal surface 20 applies a force to the cord 12 to at least partially collapse, bunch together and/or crumple the cord 12 within the passage 18 of the sheath 16 during the retraction of the sheath 16 so that the cord 12 does not rotate within the sheath 16.

It is understood that length of the sheath 16 in the configuration of FIG. 6 may range from a length equal to about the length of the sheath in the configuration of FIG. 3 to a length slightly less than the length of the sheath 16 in the configuration of FIG. 5. Further, it is understood that the sheath 16 is able to retract due to its elasticity and its being stretched within its elastic regime, in which case the deformation that the sheath 16 experiences during stretching is not permanent. Still further, it is understood that the sheath 16 may be permitted to retract in a variety of ways such as, for example, by grasping the end portion 16b and/or the fitting 24 and guiding the sheath 16 back to its relaxed configuration, or by letting go of the sheath 16 and allowing the sheath 16 to snap back to its relaxed configuration from its stretched configuration.

While the present apparatus and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible apparatuses and methods available for storing a cord within a sheath, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. An apparatus comprising:
a flat sheath defining a passage through which a flat cord is adapted to extend, the sheath having an opening through which the cord is adapted to extend, said opening having a flat configuration similar to, but slightly larger than, the width and height of the cord; wherein the sheath comprises:
a first configuration in which the sheath has a first length, and a first amount of the cord is disposed within the sheath when the cord extends through the sheath and through the opening;
a second configuration in which the sheath has a second length wherein the second length is greater than the first length; and
a third configuration in which the cord extends through the sheath and at least a portion of the internal surface of the sheath engages at least a portion of the cord, and a second amount of the cord is disposed within the sheath wherein the second amount of the cord is greater than the first amount of the cord.

2. The apparatus of claim 1, wherein the opening is integral to a fitting connected to an end portion of the sheath and through which the cord is adapted to extend.

3. The apparatus of claim 1, wherein in the first configuration, the second configuration and the third configuration, the sheath and the cord remain in substantially the same alignment.

4. The apparatus of claim 1, wherein the configuration of the opening and the engagement between the internal surface of the sheath and the cord resists rotational movement between the cord and the sheath.

5. The apparatus of claim 1, wherein the sheath functions as packaging for the cord in the third configuration.

6. The apparatus of claim 1, wherein the sheath functions as a storage device for the cord in the third configuration.

7. The apparatus of claim 1, further comprising the cord.

8. A method comprising:
extending a flat cord through a flat sheath having a first length so that a first amount of the cord is disposed within the sheath, the sheath having an opening through which the cord is adapted to extend, said opening having a flat configuration similar to, but slightly larger than, the width and height of the cord;
stretching the sheath to a second length that is greater than the first length; and
permitting the sheath to retract to a third length that is less than the second length so that a second amount of the cord is disposed within the sheath wherein the second amount is greater than the first amount;
wherein during the stretching and retraction, the width and height of the sheath and the cord remain in substantially the same alignment.

9. The method of claim 8, wherein the opening is integral to a fitting connected to an end portion of the sheath and through which the cord is adapted to extend.

10. The method of claim 8, wherein the configuration of the opening and the engagement between the internal surface of the sheath and the cord resists rotational movement between the cord and the sheath.

11. The method of claim 8, wherein the sheath functions as packaging for the cord in the third configuration.

12. The method of claim 8, wherein the sheath functions as a storage device for the cord after retraction.

13. An apparatus comprising:
means for defining a passage through which a flat cord is adapted to extend, the means for defining a passage having an opening through which the cord is adapted to extend, said opening having a flat configuration similar to, but slightly larger than, the width and height of the cord; wherein the means for defining a passage comprises:
a first configuration in which the means for defining a passage has a first length, and a first amount of the cord is disposed within the means for defining a passage when the cord extends through the means for defining a passage and through the opening;
a second configuration in which the means for defining a passage has a second length wherein the second length is greater than the first length; and
a third configuration in which the cord extends through the means for defining a passage and at least a portion of the internal surface of the means for defining a passage engages at least a portion of the cord, and a second amount of the cord is disposed within the means for defining a passage wherein the second amount of the cord is greater than the first amount of the cord.

14. The apparatus of claim 1, wherein the opening is integral to a fitting connected to an end portion of the means for defining a passage and through which the cord is adapted to extend.

15. The apparatus of claim 1, wherein in the first configuration, the second configuration and the third configuration, the means for defining a passage and the cord remain in substantially the same alignment.

16. The apparatus of claim 1, wherein the configuration of the opening and the engagement between the internal surface of the means for defining a passage and the cord resists rotational movement between the cord and the means for defining a passage.

17. The apparatus of claim 1, wherein the means for defining a passage functions as packaging for the cord in the third configuration.

18. The apparatus of claim 1, wherein the means for defining a passage functions as a storage device for the cord in the third configuration.

19. The apparatus of claim 1, further comprising the cord.
